(19) United States
(12) Patent Application Publication
(10) Pub. No.: US 2002/0143639 A1
(43) Pub. Date: Oct. 3, 2002

(54) Method of doing business using music gaming for on-line music sales, entertainment, and/or advertising

(76) Inventors: Justin F. Beckett, Chapel Hill, NC (US); Dorika Mamboleo, Chapel Hill, NC (US)

Correspondence Address: JINAN GLASGOW, P O BOX 28539, RALEIGH, NC, 276118539

(21) Appl. No.: 09/818,809

(22) Filed: Mar. 27, 2001

(51) Int. Cl. G06F 17/60

(52) U.S. Cl. 705/26

(57) ABSTRACT

A method of doing business wherein music gaming is used for on-line promotion of business. The business may be on-line music sales, on-line entertainment, on-line advertising, and combinations thereof. The music games use trivia-based games that include genre-specific categories from which questions can be drawn. These categories include categories relating to musical styles, such as jazz, rock, and blues, and other categories, such as advertising, products, time periods, musicians, musical groups, and nationalities.

### BACKGROUND OF THE INVENTION

(1) Field of the Invention

The present invention relates generally to the area of trivia games and, more particularly, to genre-specific music trivia games for use in promotion of on-line music sales, entertainment, and/or advertising.

(2) Description of the Prior Art

Typically, it is known in the prior art to provide a database for remote, online participation by players of a game. Additionally, it is known to use a method for multiple user interactive game playing, including multiple concurrent playing, including feedback regarding relative skill and/or results level. Finally, server-based wide area network gaming is known, especially including prizes and redemption thereof based on successful play.

U.S. Pat. No. 6,174,237 issued Jan. 16, 2001 to Stephenson for Method for a game of skill tournament teaches a game that is played over an interactive computer system, and claims it to be challenging while providing feedback to a player regarding his/her comparable skill level versus other players. The game comprises a qualifying round played against a computer; in a playoff round multiple players play simultaneously against a computer and rewards are given for highest points.

U.S. Pat. No. 5,779,549 issued Jul. 14, 1998 to Walker, et al. for Database driven on-line distributed tournament system teaches a game wherein remotely located players participate through devices connected to a central controller. The system includes software and hardware to implement the following steps: a) identifying player, b) responding to payment of entry fee by player, c) accessing a database to store information generated by player, and d) awarding a prize to player for performance achievement. Further steps could include elimination or disqualification of players in tournament rounds.

U.S. Pat. No. 5,695,400 issued Dec. 9, 1997 to Fennell Jr. et al. for Method of managing multi-player game playing over a network teaches a method of managing user inputs and displaying outputs in a multi-player game played on a plurality of terminals on a network, and includes a) transmitting a game challenge, such as a trivia question, to the terminals, b) receiving game response from the terminals, c) assigning each responding terminal a priority rank according to response signals, such as elapsed time, d) determining which terminal has highest rank, and e) sending signals to responding terminals assigning them respective degrees of control of game in accordance with their ranks.

U.S. Pat. No. 6,007,426 issued Dec. 28, 1999 to Kelly et al. for Skill based prize games for wide area networks teaches a prize redemption system that includes a server in communication with the game apparatuses to form a wide area network that may include the Internet. The game is provided on a game apparatus in exchange for monetary input and prized credits are awarded based on game outcome. Players may then select a prize corresponding to credit amount from a prize selection menu, and players are then issued a ticket redeemable for that specific prize.

U.S. Pat. No. 5,734,413 issued Mar. 31, 1998 to Lappington et al. for Transaction based interactive television system teaches an interactive television system, where a signal is received and decoded by a settop device which sends an infrared decoder signal to a handheld device. The system stores data for viewers, such as player information and scores, and allows many interactive programs to run concurrently over extended periods of time.

A variety of games are offered for play via the Internet, including trivia games. The trivia games currently playable via the Internet offer a variety of trivia categories, such as TV, music, science, art/literature, sports, etc. Some of these trivia game sites offer the user the possibility of choosing a category and/or accumulate points earned during play. However, none of these Internet gaming sites provide music trivia games for the purpose of selling music or music-related products.

Several types of games exist to aid in the selling of products. However, these games are static and are normally renewable only by considerable alteration of the game mechanisms. However, trivia games, and especially music-based trivia games, are easily renewable by the addition of new trivia, and thus are dynamic games with which the user will return even after considerable play because the game continues to remain novel.

Furthermore, no prior art teaches a method of doing business that uses a software music-based game to sell or advertise products or provide entertainment during Internet or online shopping. More specifically, no prior art teaches a method of doing business that uses music-trivia based gaming to sell or advertise musical products or music-related products, particularly online.

Thus, there remains a need for a method of business that uses a music-based game to sell or advertise products or provide entertainment during Internet or online shopping. More specifically, there remains a need for a method of doing business that uses music-trivia based gaming to sell or advertise musical products or music-related products online.

### SUMMARY OF THE INVENTION

The present invention is directed to a method of doing business using software-based music gaming for businesses, particularly for on-line music sales, entertainment, advertising, and combinations thereof.

The present invention is further directed to a method for doing such business using music gaming wherein the games are music trivia-based. Furthermore, the present invention is directed to a method for doing business using software-based music gaming for internet-related business, particularly for online music sales, entertainment, advertising, and combinations thereof.

Accordingly, one aspect of the present invention is to provide a method of doing business using music gaming for businesses, particularly for on-line music sales, entertainment, advertising, and combinations thereof.

Another aspect of the present invention is to provide a method of using music gaming to perform such business wherein the games are music trivia-based. Still another aspect of the present invention is to provide a method for doing business using software-based music gaming for internet-related business, particularly for online music sales, entertainment, advertising, and combinations thereof.

These and other aspects of the present invention will become apparent to those skilled in the art after a reading of the following description of the preferred embodiment when considered with the drawings.

### BRIEF DESCRIPTION OF THE DRAWINGS

FIG. 1 is a schematic data flow diagram for a conceptual data model of a preferred embodiment according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The preferred embodiment according to the present invention is a method of doing business wherein music gaming is used for on-line promotion of business, wherein at least one user, preferably a multiplicity of users, possibly simultaneously, access a website via at least one remote computer having a user interface screen, whereby the at least one user can view, hear, interact, and enter information related to the music game. The business may include music sales, on-line entertainment, advertising, and the like. The music gaming uses music trivia-based games with audio and visual components to attract the user and maintain the user's attention. In a preferred embodiment, the trivia games are genre-specific. Genre-specific games are advantageous because most persons are attracted to a particular genre of music, and therefore will tend to stay engaged with a game longer if the game is dealing with a music genre they prefer. Contrarily, trivia games in which the user is forced to answer questions from a non-preferred genre often result in the user quitting the game prematurely. The games are also designed to provide questions for different skill levels, thus providing the user with a satisfactory rate of success and ensuring that the user will continue to play the game and not quit prematurely. Additionally, the regular scheduling of games and contests will ensure a consistent level of repeat visits to the gaming site.

The music gaming system according to the present invention is internet-based, with a front end for providing the user interface and a back end for providing game operation. At least one user, preferably a multiplicity of users, accesses the front end through a website that is visible on at least one computer screen, preferably a multiplicity of remote computer screens simultaneously. The front-end, including a user interface, provides the questions to the at least one user, and is interactive, such that the user(s) can provide answers to the questions in addition to performing other interactions, such as choosing the genre of music about which to answer question. Preferably, multiple users play the gaming system simultaneously. Also, these multiple users may play the game in a coordinated fashion, such as tournaments or two-player matches. In a preferred embodiment, the user interface is always conspicuous for the user(s) on a computer screen.

In an alternative embodiment, the user gaming interface is not conspicuous when the user(s) is actively browsing the website, such as when shopping for products on a product-related website, but remains in the background. The gaming interface becomes conspicuous during user waiting periods, such as when the user(s) has placed an order and is waiting for the order to be processed, for example, in a checkout process. During these time periods, the gaming interface will appear on a computer screen and prompt the user(s) to initiate play of or resume playing the music trivia game. By entertaining the user(s) during these waiting periods, the game prevents user boredom and thus further gratifies the user experience at the site. Additionally, the user(s) might be prompted by the trivia to order some other item prior to leaving the site.

The user interface connects at least one remote user to a back end, which includes a database, preferably a proprietary database, and a multiplicity of game types. More particularly the user interface is provided by an application service/server provider (ASP) model, wherein the at least one remote user is directly connected to and/or is linked via another website to the front end website, including the ASP, for connecting with the database and its contents. In the preferred embodiment, the database contains a multitude of questions with answers, preferably greater than 20,000 questions with answers, that have been collected and have been independently confirmed to be accurate questions and answers.

In the preferred embodiment, the back end provides the game rules, game scoring, game user history, and different game questions from a database. The database includes a platform that consists of SQL database/ISP/Flash coding with sound clips. The database provides accurate questions with answers chosen from a broad selection of trivia. In a preferred embodiment, the broad trivia selection includes a broad selection of music-related categories as well as a broad selection of questions with answers from each category. The broad selection of categories ensures that a user will find a category of his/her preference, while the broad selection of questions with answers in each category provides that the user will not repeat a question frequently. Preferably, the selection of questions with answers in each category is such that the instances of a user repeating a question prior to completing 1000 questions are rare. The database selections are also continuously augmented with new trivia, such that the chance of repeating a question continues to decline.

The database, in addition to providing text questions, may also provide sound bytes and visual clips to enhance the enjoyment of the game. The sound bytes may be musical bytes such as excerpts from songs or other musical renditions, or may be non-musical sounds such as speech. Because the user is music-oriented, the use of musical bytes will enhance the enjoyment of playing the game. The visual clips may also be used to enhance the user's experience. Finally, music videos, which combine musical bytes and visual clips, may be used.

The gametypes used in the preferred embodiment are trivia-based. Although simple question and answer games are provided, other games that utilize trivia, such as crossword puzzles, short-term memory games, and audio and/or visual recognition games, may be provided. Some examples follow:

Example 1—Trivia Challenge. The Trivia Challenge game consists of ten music-related multiple-choice music trivia questions to be answered within a two-minute period. Each question has an answer set of five options, with one of the choices being the clear, correct answer. While playing the game, players have the option of listening to genre specific song bytes.

Example 2—Memory Match. Memory Match is a variation of the popular game of Concentration. Each game features eight pairs of unrevealed matching tiles of category specific artists, album covers, logos, etc. The player clicks on a tile, revealing the hidden picture. The player then clicks on a second tile, trying to match the first. The object of the game is to successfully pair all the tiles in the least number of tries.

Example 3—Picking Hits. Picking Hits is an event-driven game that measures the player's ability to anticipate popular music trends. Players select a music category, and then answer a number of questions related to the success of particular artists within that category. The trends that the player may predict include record sales, single sales, radio airplay, video airplay, number of downloads and largest sales gains. After a specified period, usually between one and four weeks, all the players' predictions are scored and ranked based on accuracy.

Example 4—Name The Artist. Name The Artist is a music identification game consisting of a series of ten sound bytes taken from the player's chosen musical category. After listening to the sound byte, the player chooses the correct answer from an answer set of five options within a set period of time.

Example 5—Music ShufflePuzzle. The Music ShufflePuzzle is a music-related puzzle. The player selects a music category from which a picture, likely a photograph of an artist or album cover, is fragmented into a scrambled tile puzzle. The player then uses their mouse to slide the tiles to correctly reconfigure the picture. The game is timed and the player earns points based on the speed of completing the puzzle.

Example 6—Music Crosswords. The Music Crosswords are music-related and category specific crossword puzzles. The player attempts to complete a puzzle consisting of 75 clues and answers relating to the chosen musical category. The game features an overall timer function, and a way for the player to get letter or word clues. The player earns points for completing the puzzle quickly with points being subtracted for the use of clues.

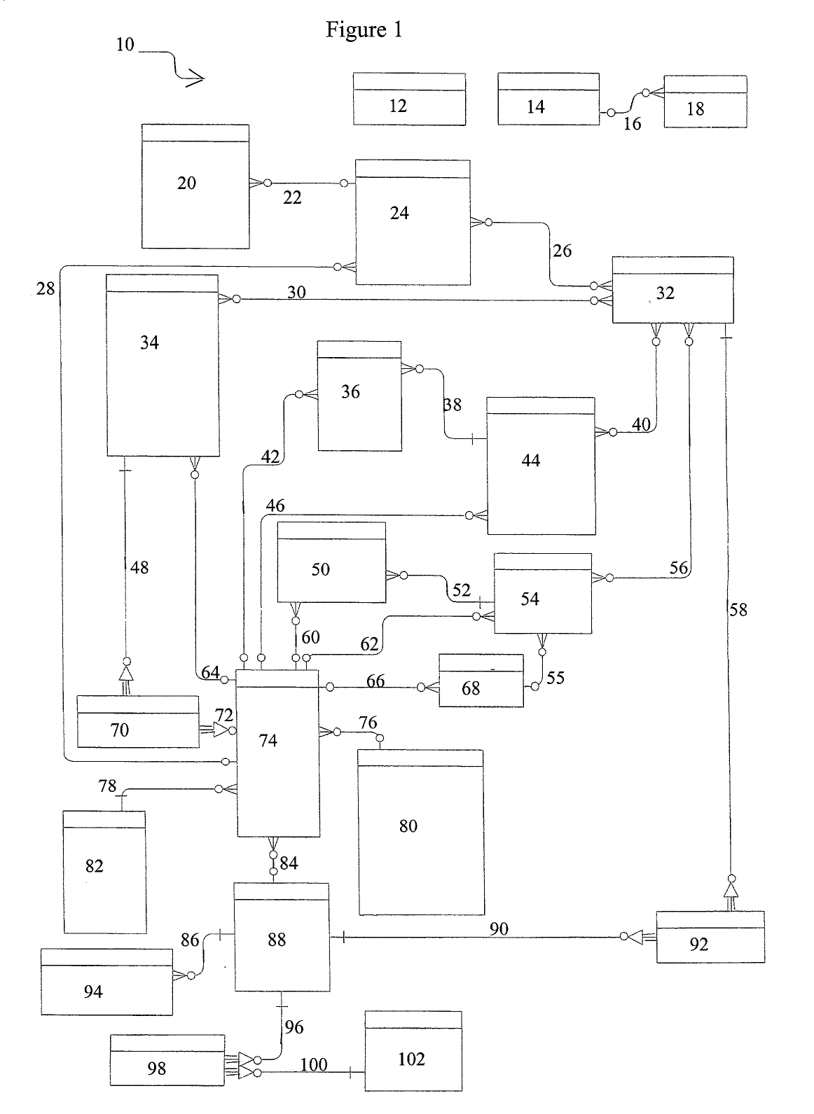

Referring now to the drawings in general, the illustrations are for the purpose of describing a preferred embodiment of the invention and are not intended to limit the invention thereto. A schematic data flow diagram for a conceptual data model of a preferred embodiment according to the present invention, generally referenced as 10, is shown in FIG. 1. In this model, the Global Settings Table 12 provides the Global Picture Path and Global Song Path. The GamerLog Table 18 generates the GamerLogID and allows logging on via the Log Entry. The GamerLog Table transmits the GamerLogs via the GamerLogs Junction 16 to the Gamer Table 14. The Gamer Table provides the Gamer Identification and Gamer IP Address. These components combined are the Global Independent Data Structure and are not directly part of the functioning game. The Users Table 74 contains the individual User Ids, comprised of the user's first and last name, email address, company, department, telephone number, fax number, username, and password. This UserID is linked to an Address Table 82, which contains the user's physical address information. Data is transmitted between the Users Table and the Address Table via the UserAddress Junction 78. The Users Table is also linked via the UserType Junction 76 to the UserType Table 80, which provides information on the UserTypeID, including the UserTypeName, the UserTypeDescription, The SystemAdminFlag, the SystemReviewerFlag, the SystemEditorFlag, the SystemAuthorFlag, the SiteAdminFlag, the SiteUserFlag, and the SiteReportFlag. The Users table interfaces with the Site Table 88 via the SiteUsers Junction 84. The Site Table provides the SiteID, the SitePrefix, the SiteName, the SiteDescription, the SiteRootDirectory, and the SiteComments. The Site Table interfaces with the SiteImages Table 94 via the SiteImages Junction 86 that provides SiteImagesID, SitelmageFileJunction and SiteImageDescription. The Site Table also interfaces with the SiteBannerJunc Table 98, which provides, via the BannerSite Junction 96, the Banner Rotation Constant and the Banner Rotation Timing. The SiteBannerJunc Table interfaces through the SiteBanner Junction 100 with the SiteBanners Table 102, which provides the BannerID, BannerType, BannerFileJunction, and BannerTitle. The Site Table also communicates with the SiteCategoryJunc Table 92, via the SiteCat Junction 90 to provide the CatPercent. The SiteCategoryjunc Table also communicates, via the CateSiteJunction 58, with the Categories Table 32, which provides the CategoryID, CategoryName, and Category Description.

The Users Table communicates with several Question/Answer Tables, depending on the type of game being played. Thus, the Users table can communicate with the CrossWord Table 24 via the AuthorCrossword Junction 28, TriviaQuestions Table 34 via the AuthorTrivia Junction 64, the NameArtists Table 36 via the AuthorNameArt Junction 42, the CorrectNames Table 50 via the AuthorConnect Junction 60, the Songs Table 44 via the AuthorSongs Junction 46, the Pictures Table 54 via the AuthorPictures Junction 62, the PickingHits Table 68 via the AuthorPickHits Junction 66. The CrossWord Table provides the CrosswordID, the Cross Title, the CrossSettingsInt, the CrossDescription, the CrossUnitLength, the CrossUnitHeight, and the CrossStorage String. The CrossWord Table also interfaces with the Categories Table via the CrosswordCat Junction 26, and with the CrosswordHints Table 20 via the CrossHint Junction 22. The CrosswordHints Table provides the CrosswordHintID, the Hint, the Answer, the Source, the Location X, the Location Y, and the Length. The TriviaQuestions Table provides the QuestionID, the Question, Answers 1 through 5, the Difficulty Level, the Source, the Active Flag, and the Approved Flag. The TriviaQuestions Table also interfaces with the Categories Table via the QuestionCat Junction 30. The NameArtist Table provides the NameArtistID and Answers 1 through 5. The Songs Table provides the SongID, the SoundFileJunction, the SoundFileLength, the Artist, the Song Title,the Album Title, the Publish Year, and the ScanCode. The Songs Table also interfaces with the Categories Table via the SongCatJunction 40. The NameArtist Tble and the Songs Table interface via the NameSongs Junction 38. The CorrectNames Table provides the CorrectNamesID, the CorrectName, IncorrectName1, and IncorrectName2. The Pictures Table provides the PicturelD, the PictureType, the PictureFileJunction, and the PictureTitle. The Pictures Table also interfaces with the Categories Table via the PicCatJunction 56. The ConnectNames Table and the Pictures Table connect via the NamePictures Junction 52. The PickingHits Table provides the PickingHitsId and the Question to the Users Table via the AuthorPickhits Junction 66. The PickingHits Table also interfaces with the Pictures Table via the PickHitsPic Junction 55.

The Users Table also interfaces with the RevComm Table 70, which provides ReviewerComments via the RevCo Junction 72. The RevComm Talbe interfaces with the TriviaQuestions Table via the ReviewerComments Junction 48.

The controls, commands, and other interactions of the system are provided by software. The gaming system and user may interact in various ways. For example, the game may prompt the user to perform a task or some other action, such as requesting the user to choose the correct response to a question. When the user responds, the system replies appropriately. Alternately, the gaming system may not prompt the user, but simply provide an opportunity for input by the user, to which the system then responds with an output.

As is demonstrated in FIG. 1, the system can provide trivia questions, artist names, questions, songs questions, picture questions, and other types of questions from a particular category. At some time during play, preferably after completion of a round, the system displays to the user(s) a list of music products related to the category being played or just played, such as CD music recordings by an artist or group just heard during the round, and asks the user(s) if he/she would like to purchase one or more of the items displayed. The user(s) can then choose from several options, including elect to purchase one or more of the items, add them to a shopping list, and continue to play the game.

In general, the trivia-based games are genre-specific, for the reasons cited previously. Namely, most persons are attracted to a particular genre of music, and therefore will tend to stay engaged with a game longer if the game is dealing with a music genre they prefer. Therefore, the genres are predetermined styles of music such as Rock, Jazz, Country, Rap, Hip-Hop, Rhythm and Blues, Alternative, Latin, Heavy Metal, Punk Rock, Techno, Surf, Disco/House, Beach, Gospel, Swing, Drummers, Zydeco, Salsa, Soul, Classic Soul, Classic Rock, Blues, Reggae, Dance Hall, Bluegrass, Rockabilly, Big Band, Doo Wop, Indie Rock, Opera, Classical, International, Oldies, Christian, Religious, Electronica, Instrumental, Lyrical, and the like. Alternately, other non-music-style categories may be included, such as music trivia related to advertising, products, time-periods, musicians, musical groups, nationality, and the like. Examples include Pop, #1 Hits, 90's Music and Beyond, 80's Music, The Beatles, Teen Scene, Alternative, Music Masters, College Radio, Women in Rock, Masters, One Hit Wonders, Movie Music, Glam Rock, Guitar Gods and Goddesses, Family Affairs, Singers & Standards, The Rolling Stones, '50s & '60s, Bass Players, Kings & Queens of the Keys, Crimes & Misdemeanors, Singers who act and Actors who sing, Love Songs, Grateful Dead, Michael Jackson, Madonna, Classic Covers, Elvis, Billboard #1 Hits, Divas, and Player's Choice. A random category may also be provided.

Certain modifications and improvements will occur to those skilled in the art upon a reading of the foregoing description. By way of example, alternative music categories and mixtures thereof may be used. Also, the music gaming may be sold as a free-standing software package, or by subscription and through a link to a website and server supporting the game. All modifications and improvements have been deleted herein for the sake of conciseness and readability but are properly within the scope of the following claims.

1. A method for generating revenue based on music gaming comprising the steps of: providing a computer-based game that at least one remote user can access via Internet website displayed on at least one remote computer.

2. The method of generating revenue according to claim 1, wherein the revenue is generated by online music sales.

3. The method of generating revenue according to claim 3, wherein the online music sales are generated by prompting the user at the end of a game session to purchase music feature in that game session.

4. The method of generating revenue according to claim 1, wherein the computer-based game includes the steps of
a) providing a gaming system that includes a front end for user interface, a database, and a game;
b) logging at least one user onto the game from at least one remote computer;
c) verifying by a database the at least one user's userid and password;
d) beginning a game session by selecting a game and a trivia category;
e) providing questions to the user for the user to answer;
f) scoring the answers provided by the user;
g) prompting the user to buy products related to the game session after the end of the game session.

5. The method of generating revenue according to claim 1, wherein the game uses music trivia based games.

6. The method of generating revenue according to claim 5, wherein the music trivia based games are genre-specific.

7. The method of generating revenue according to claim 1, wherein the revenue is generated by fee-based online entertainment.

8. The method of generating revenue according to claim 1, wherein the revenue is generated by fee-based online advertising.

9. A system for computer-based gaming, comprising an internet-based computer game, hosted on a remote database and accessed via the Internet, which supplies the format to provide a multiplicity of music-based games types playable by at least one remote user.

10. The system according to claim 9, wherein the internet-based computer game can be played simultaneously by at least two remote users.

11. The system according to claim 9, wherein the internet-based computer game can be played in a coordinated fashion by at least two remote users.

12. The system according to claim 9, wherein the internet-based computer game has a front end for the user interface and a back end for game operation.

13. The system according to claim 12, wherein the user interface provides interaction with the at least one remote user.

14. The system according to claim 13, wherein the interaction is composed of inputs by the at least one remote user and outputs by the system.

15. The system according to claim 13, wherein the interaction is composed of prompts by the system to the at least one remote user, inputs by the at least one remote user, and outputs by the system.

16. The system according to claim 12, wherein the user interface is provided via website access.

17. The system according to claim 12, wherein the user interface is provided via an ASP model.

18. The system according to claim 12, wherein the user interface is linked to at least one other website for providing a link to a host website and server.

19. The system according to claim 12, wherein the user interface is not conspicuous during active browsing of the website but is conspicuous during user waiting periods.

20. The system according to claim 12, wherein the user interface has visual components.

21. The system according to claim 12, wherein the user interface has audio components.

22. The system according to claim 12, wherein the user interface has audio and visual components.

23. The system according to claim 12, wherein the back end provides game rules.

24. The system according to claim 12, wherein the back end provides game scoring.

25. The system according to claim 12, wherein the back end provides game user history.

26. The system according to claim 12, wherein the back end provides different questions.

27. The system according to claim 9, wherein the database includes a platform including a SQL database, an ISP, and Flash coding with sound clips.

28. The system according to claim 9, wherein the database provides accurate questions with answers.

29. The system according to claim 9, wherein the database provides a broad selection of trivia.

30. The system according to claim 29, wherein the broad selection of trivia includes a broad selection of categories.

31. The system according to claim 29, wherein the broad selection of trivia includes a broad selection of questions with answers.

32. The system according to claim 29, wherein the broad selection is so broad such that the instances of repetition in playing 1000 questions are rare.

33. The system according to claim 9, wherein the database is augmented continually.

34. The system according to claim 9, wherein the database provides text.

35. The system according to claim 9, wherein the database provides sound bytes.

36. The system according to claim 9, wherein the database provides visual clips.

37. The system according to claim 9, wherein the gametype is trivia-based.

38. The system according to claim 37, wherein the trivia-based gametype is genre-specific.

39. The system according to claim 38, wherein the genre are predetermined music categories.

40. The system according to claim 39, wherein the predetermined music categories are music styles.

41. The system according to claim 40, wherein the music styles are selected from the group consisting of Rock, Jazz, Country, Rap, Hip-Hop, Rhythm and Blues, Alternative, Latin, Heavy Metal, Punk Rock, Techno, Surf, Disco/House, Beach, Gospel, Swing, Drummers, Zydeco, Salsa, Soul, Classic Soul, Classic Rock, Blues, Reggae, Dance Hall, Bluegrass, Rockabilly, Big Band, Doo Wop, Indie Rock, Opera, Classical, International, Oldies, Christian, Religious, Electronica, Instrumental, Lyrical, and combinations thereof.

42. The system according to claim 39, wherein the predetermined music categories are non-music style categories.

43. The system according to claim 42, wherein the non-music style categories are selected from the group consisting of categories related to advertising, products, time periods, musicians, musical groups, nationalities, music types, and combinations thereof.

44. The system according to claim 39, wherein the predetermined music categories are random.
